(19) United States
(12) Patent Application Publication
(10) Pub. No.: US 2002/0004844 A1
(43) Pub. Date: Jan. 10, 2002

(54) Method and system for enabling the exchange, management and supervision of leads and requests in a network

(76) Inventors: Yali Harari, Tenafly, NJ (US); Shimon Lior Rokach, Kfar-Saba (IL); Yizhak Eitan Klevansky, Holon (IL); Ben Zion Galili, Ramat Hasharon (IL); Igor Tsenter, Ramat-Gan (IL)

Correspondence Address: Proskauer Rose LLP, Patent Department, 1585 Broadway, New York, NY, 10036, US

(21) Appl. No.: 09/801,560

(22) Filed: Mar. 8, 2001

Related U.S. Application Data
(60) Provisional application No. 60/187,667, filed on Mar. 8, 2000.

(51) Int. Cl. G06F 15/173

(52) U.S. Cl. 709/238

(57) ABSTRACT

A method and system to enable the exchange, management, and supervision of the handling of leads and requests, to a provider, in a network includes a first input configured to receive request data from a user, a second input configured to receive a routing policy from a provider, wherein the routing policy includes a plurality of rules. Each rule is interpretable and/or executable by a computer. In addition, the method and system include a first processor configured to receive the request data from the first input and the routing policy from the second input, and to make a routing decision based at least on the request data and/or a user profile, to an end-provider, according to the routing policy. Further, the method and system include a first output configured to receive the routing decision from the processor, and route the request data to at least one end-provider according to the routing decision.

### RELATED APPLICATION

This application is based upon provisional application Ser. No. 60/187,667, entitled “METHOD AND SYSTEM FOR ENABLING THE EXCHANGE, MANAGEMENT AND SUPERVISION OF LEADS AND REQUESTS IN A NETWORKED COMPUTER SYSTEM,” filed on Mar. 8, 2000 for Yali Harari, Shimon Lior Rokach, Ethan Klevansky, Ben Zion Galili, and Igor Tsenter. The contents of this provisional application are fully incorporated herein by reference.

### FIELD OF THE INVENTION

The present invention relates to the field of trafficking and supervising leads and requests in a networked computer system, or other networked system.

### BACKGROUND OF THE INVENTION

Persons who seek a product, service or information will frequently search for an entity that may fulfill his needs. This may be done manually, or semi-automatically by logging on to a computer, or by accessing the World Wide Web. For example, when a person finds an entity that he believes can fulfill or handle his request, he typically submits a request to that entity. This entity will be referred to herein as the provider. Upon receiving the request, the provider may:

(1) process or answer the request by supplying the requested product, service, advice, or information;

(2) forward the request, either manually or semi-automatically, to a partner of the provider; or

(3) forward the request, again manually or semi-automatically, to another provider in a network, if such a network exists.

In practice, however, providers frequently encounter difficulties processing such requests. These difficulties can result from several causes:

The provider can be overwhelmed by too many requests, some of which it cannot handle (for instance because the requester didn't fill in all required information, or because the requester asks for information, or a service that the provider can't provide), or a request that the provider does not wish to handle (see 2 and 3 above).

The provider can encounter difficulty routing the request to its partners, and this can result in a low level of service, and/or lower profits to the provider from business relations with its partners.

The provider may not get a request that has been submitted to one of the provider's partners (requests that might be relevant to the provider).

A request that neither the provider nor its partners can handle is seldom responded to. This typically is because the provider either does not know who to forward the request to, or because the provider does not stand to profit from routing the request. As a result, the requester receives a low level of service.

Due to the fact that a request may be handled by different end-providers who may use different kinds of messaging technologies (e.g., e-mail, phone, fax, or web form), there are also difficulties in supervising the handling of requests. For example, the provider that received the original request typically cannot track the status of the request after it has been routed to a partner of that provider.

What is desired, therefore, is a system and method for enabling the exchange, management, and supervision of leads and requests, in a networked computer system, that overcomes the above-described handling, and supervising difficulties of conventional systems and methods.

### SUMMARY OF THE INVENTION

This invention provides a method and a system for enabling the exchange, management, and supervision of the handling of leads and requests, to a provider, in a networked computer system.

The system and method disclosed overcome the disadvantages of the prior art by facilitating the exchange of requests between non-competing providers (i.e., partners) helping ensure that each provider will get relevant requests from its partners, and that the number of irrelevant requests a provider needs to process will be decreased dramatically. The system and method disclosed also overcome the disadvantages of the prior art by providing a mechanism for supervising the handling of requests.

In particular, in one embodiment of the present invention, a method and system for processing a user request for services, from a user, is disclosed. The system includes a first input configured to receive request data from a user, a second input configured to receive a routing policy from a provider, wherein the routing policy includes a plurality of rules. Each rule is interpretable and/or executable by a computer. In addition, the method and system include a first processor configured to receive the request data from the first input and the routing policy from the second input, and to make a routing decision based at least on the request data and/or a user profile, to an end-provider, according to the routing policy. In addition, the routing decision can be further based on end-provider profiles. Further, the method and system include a first output configured to receive the routing decision from the processor, and route the request data to at least one end-provider according to the routing decision.

As an aspect of this embodiment, the request data is formatted into a data oriented structure, such as XML. Accordingly, the computer processes the routing policy using the data structure.

As a further aspect of this embodiment, the routing policy includes an instruction not to route the user request to a predetermined competitor of the provider. The routing policy may also include an instruction to forward a notification to the user if at least one end-provider has not accepted the user request within a predetermined period of time. The routing policy may further include an instruction to forward the user request to a non-partner provider if at least one end-provider has not accepted the user request. In addition, the routing policy may require a processing of the user request within a predetermined period of time. Further, the routing policy may determine the order in which the user request is processed in relation to a plurality of other requests.

In another embodiment of the present invention, a method and system for a provider to configure and manage a request service, where the request service processes user requests for a service, from one or more users, is disclosed. In the method and system, the provider subscribes to the request service. Further, the provider provided a request form definition to the request service, where the request form definition defines request data fields, such that a subsequent user request for a service includes request data corresponding to the request data fields. The provider further provides a routing policy to the request service to determine the protocol for routing said request to at Least one end-provider, such that the request is routed based on the request data to at least one end-provider based on the routing policy of the provider.

### BRIEF DESCRIPTION OF THE DRAWINGS

The following detailed description, given by way of example and not intended to limit the present invention solely thereto, will best be understood in conjunction with the accompanying drawings, in which:

FIG. 1 shows a block diagram of a preferred embodiment of the invention.

FIG. 2 shows a block diagram for a method of request routing from an end-provider's point of view.

FIG. 3 shows a block diagram of a system for the routing of a request to an in-house, or internal provider.

FIG. 4 shows a block diagram for a method of request routing from a user's point of view.

FIG. 5 shows a block diagram of a system for routing a request to a provider within a company, entity, or organization (i.e., in-house routing).

FIG. 6 shows a block diagram of a system for routing a request to a business partner, or external to a provider.

### DETAILED DESCRIPTION OF THE PREFERRED EMBODIMENTS

For purposes of this application, “Subscribing provider” means a provider that joins a lead/request service. “Provider” means subscribing provider. Hereinafter, “person” will be referred to throughout this discussion as a requester, and “entity” or “company” will be referred to as a provider. Providers frequently have business associates or sub-contractors that they work with; these will be referred to as partners. “End-provider” means the provider that ultimately handles the request (also referred to as an “executing provider”) which may be the provider, a partner of the provider, or a non-affiliated provider. Further, the “end-provider” means the actual resource in the provider which supply the service, such as a knowledge worker or expert in the organization. In addition, although the preferred operating systems, languages, formats, databases, and software is provided, it should be understood that any desired operating system, language, format, database, and software may be utilized with the present invention, as desired.

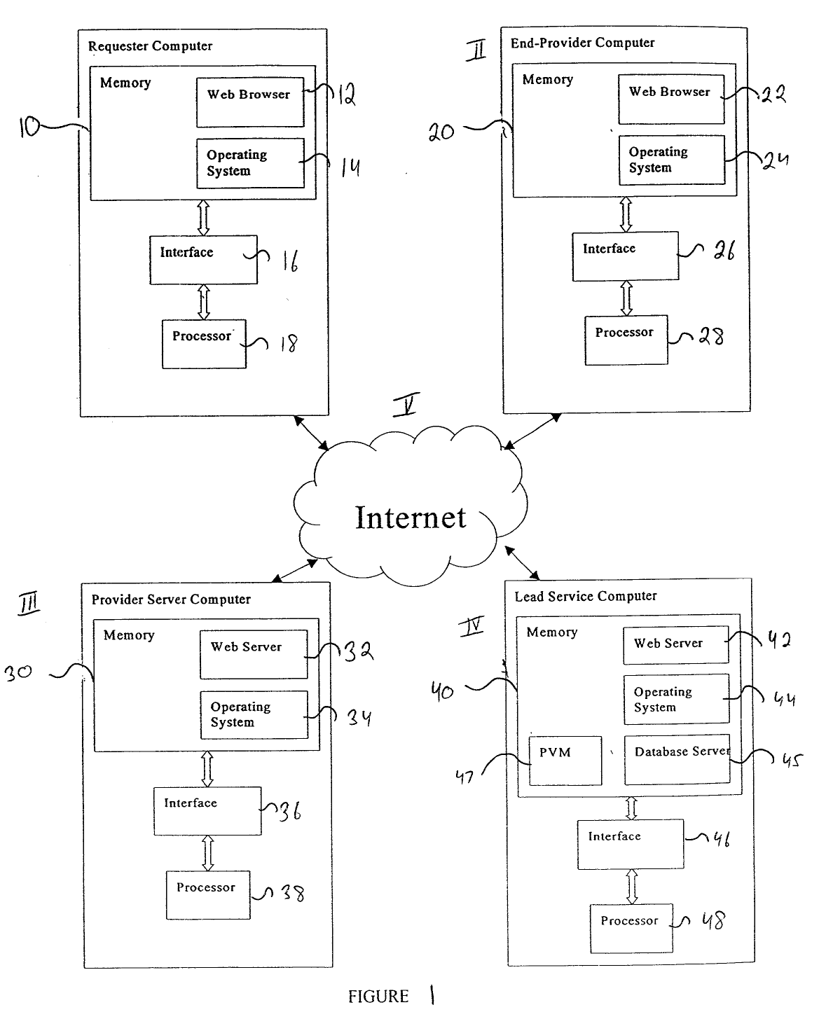

FIGS. 1, 2, 3, 4, 5, and 6 provide a more detailed illustration of the system and method in accordance with the invention.

FIG. 1 is an illustrative example of a block diagram of a lead system for implementing an embodiment of the present invention. The computer system includes a user/requester computer (I), an end-provider computer (II), a lead system computer (III), the provider server computer (IV) and a network communications mechanism (V). Note that FIG. 1 may be modified as desired.

The network communications mechanism provides a mechanism for facilitating communication between the requester computer (I), the lead service computer (IV), the end-provider computer (II), and the provider server computer (III).

The requester computer includes processor (18), a memory (10), and an interface for facilitating input and output in the requester computer (16). The memory stores a number of items, including operating system (14), and a web browser (12). The preferred operating system is Windows NT from Microsoft Inc. The preferred browser supports HTML, XNML and JavaScript, such as Internet Explorer from Microsoft Inc. The request is provided by the requester computer by filling in a request form that was supplied by the provider web server.

The requester may also submit his request using other methods such as:

A. Sending an e-mail to the provider's mail address. In that case the provider should support request form that is built into an e-mail structure that contains: From, To, CC, BCC, Title and body, and any other data that can be read from an e-mail message, such as the date of submission, mime type, etc., in case any of these are needed by the provider to conduct business.

B. Using a wireless or other mobile device or a static device, which is capable of filling in the forms.

C. Using a special application provided by the provider and should be installed on the requester computer.

The end-provider computer includes processor (28), a memory (20), and an interface for facilitating input and output in the requester computer (26). The memory stores a number of items, including the operating system (24), and a web browser (22). The preferred operating system is Windows NT from Microsoft Inc. The preferred browser should support HTML, XML and JavaScript, such as Internet Explorer from Microsoft Inc.

The provider server computer includes processor (38), a memory (30), and an interface for facilitating input and output in the requester computer (36). The memory stores a number of items, including the operating system (34), and a web server (32). The preferred operating system is Linux from Red Hat, Inc. The preferred web server is Apache, available over the Internet at http://www.apache.org. Note that the end-provider may also be the provider. In such a case, FIG. 1 would not include End-Provider Computer (II); instead, memory 30 of Provider Server Computer (II) would further include a web browser 22.

The lead service computer includes processor (48), a memory (40), and an interface for facilitating input and output in the requester computer (46). The memory stores a number of items, including the operating system (44), and a web server (42), database software (45), and a policy virtual machine (PVM) service application (47). The lead service computer comprises the policy virtual machine service application which process the provider's policies, as described above. The provider's policy can be written in a script language like Visual Basic Script or JavaScript.

An administrative tool can be employed when adding a new provider to the system. An administrative tool may also be used in setting up the system configuration for the new provider (which may include designing the provider's forms, policies, partners, etc.) The preferred operating system is Linux from Red Hat, Inc. The preferred web server software is Apache, available over the Internet at http://www.apache.org. The preferred database is Oracle from Oracle, Inc.

The database software stores the provider's request form, the request information, the provider's policy scripts, the end-provider's profile templates, and the end-provider's profile information. It should be noted that the same lead system might serve several different providers.

The following describes a preferred format to be used to form a company record from the provider information:

Provider Number,

Provider Name,

Provider Policy Script, and

Provider Request Form.

The preferred language to be used to describe a company's policy script is JavaScript. The preferred format to be used in the description of a provider's request form is XML.

The following describes a preferred format to be used to form a request record from the request information:

Request Number,

Request's Company (i.e., where the request has been submitted),

Request's Origin Provider, and

Request Information (based on the provider request form).

The preferred format to be used for describing request information is XML. The following is a description of the preferred format of the end-provider record:

End-provider Number,

End-provider Name,

Provider Number, and

E-mail Address.

As stated above, the provider's policy can be stored as Java Script, or in any other computer interpretable format. The request data, or any other data used to route the request, such as an end-provider profile, or a user profile, can be formatted in XML, or in any other suitable data structure. This invention may route the request based only on the computer interpretable policy, or based on the computer interpretable policy coupled with a data structure containing some or all of the above described information. Two examples of the use of a computer interpretable rule based policy coupled with a data oriented structure are as follows:

### EXAMPLE 1 OF A ROUTING POLICY RULE

a. Rule:

If the income of the user/requestor is greater than $100,000, then route the request to expert A123.

b. Routing Policy Rule in Interpretable Programming Language Format:

If (request.getField(“Income”)>100000) then

{

request.routeToProvider(“A123”);

}

### EXAMPLE 2 OF A ROUTING POLICY RULES

a. Rule:

Route the request to an expert that has “income” attribute closest to “income” attribute of requestor.

b. Routing Policy Rule in Interpretable Programming Language Format:

Request.routeToProviderByAttribute(“income”, “close”,Request.getField(“Income”))

It should be noted that the computers of the requester, the end-provider, the lead service, and the provider server, may all contain additional components not discussed above, such as a keyboard, a mouse, a magnetic storage device, or a CD-ROM.

The computers described above may either be general or special purpose computers that perform the operations as described above. One skilled in the art would appreciate that the use of the above described methods and systems is not limited to a particular computer configuration.

The data and information referred to herein represent physical quantities. These quantities typically take the form of electrical or magnetic signals capable of being stored, transferred, combined, compared, or otherwise manipulated. While these data may be referred to by various labels, such as information, requests, rules, policies, or the like, these terms, and similar terms used herein refer to physical quantities, and are merely convenient labels. The described data operates, resides, flows, is transferred or are otherwise manipulated by, or in, a computer, as described above, which includes a server, or a network of servers and/or computers.

Using the System from an End-provider's Point of View

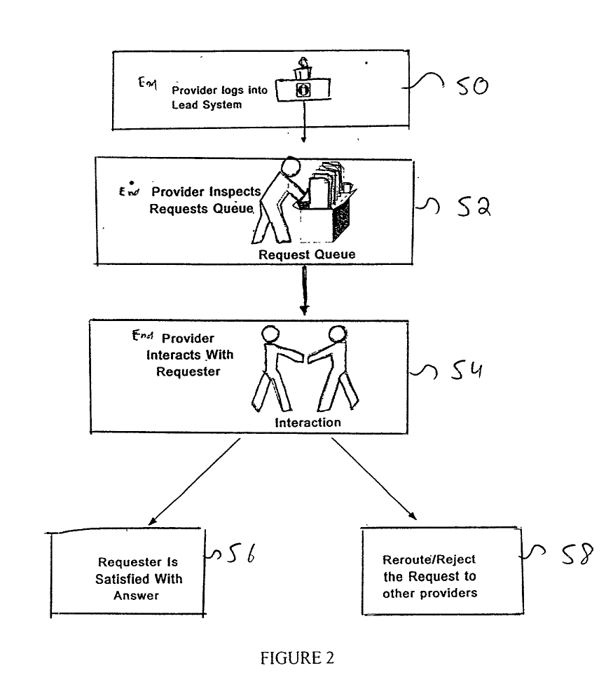

FIG. 2 illustrates the lead system from the point of view of the end-provider. The end-provider logs onto the request system (step 50). In one embodiment this may be through a secure connection, over the Internet, or through an intra-net of the end-provider. The end-provider inspects a request queue that contains a list of all of the requests that have been routed to that end-provider through the lead system (step 52). After the end-provider selects a request from the queue, the end-provider can choose to interact with the requester, either to provide an answer, provide a quote, get additional information, or to ask for a clarification (step 54). The requester can be satisfied with the answer, service, or quote provided by the end-provider (step 56), or the requester can reject the answer, service or quote, and direct that the request be redirected towards another end-provider (step 58).

The typical embodiment of the method may be described from the provider's point of view as follows:

The provider has several queues of requests routed to it by the lead system. The request will be handled by an end-provider of the provider. The end-provider may view a list of the requests, or the details of a specific request, and, according to his/hers privileges, the end-provider can choose an action which may include but is not limited to:

Add the request to his/her list of “pending” requests—requests that he/she will be handling. In the case where the request was addressed to a group of providers within the provider, doing this will lock the request to the other end-providers of the group, and they will not be able add it to their “pending” requests list. The provider then interacts with the requester in order to refine the request, make the requester a service offer, answer the request, etc.

Reject the request. Depending on the providers privileges in the system, this action might mark him/her as further unsuitable to handle this request, move the request from his/her personal queue or remove the request from the group's queue. In the later case, this will cause the request to be rerouted by the provider policy mechanism, without rerouting to providers/groups that have rejected it in the past.

Reroute the request to another end-provider/end-provider group from within the subscribing provider. This too will be performed according to end-provider's privileges.

Reroute the request to another end-provider/end-provider group external to the subscribing corporation, that is either a business partner or any other subscribed company. This too will be performed according to provider's privileges.

Configuring the System

The present invention is highly configurable by the provider. During a subscription process, each subscribing provider describes in a subscription form what industry it is involved in (e.g., commerce, support, or service). Additionally, the subscribing provider can describe what areas of that industry it is involved in. This may be done, for example, by relating the provider to one or more categories in a category tree, or a category list.

Each provider can design a request form that is specific for that provider. The request form contains the information needed by the provider to process the request. The request form can be built either statically, or dynamically, from a list of data items included in a request form definition. These data items may include fields such as: numbers; free-text; a selection from a list of values; a file; etc. The request information form can contain several logical types of data:

System Required Data: Data essential for the system to function, such as user, or requester identification.

Application Required Data: Data agreed to by the providers that share the same network. This data is essential for routing requests between different providers. For example, the data may be composed of an offered price for a requested service.

Proprietary Routing Data: Data that a provider needs in order to perform inner policy decisions (as defined hereafter), but this data is not common to other subscribed companies of the lead services. An example of this data is the number of employees in the requestor's organization.

Variant Data: Data that can be added to the request to satisfy the needs of specific application, without having an implication on the policy decision process.

The request form definition could also be made by another entity, or by the lead system. Besides the request form, the provider can define responses, in an event policy, to actions that might be performed by the requester, by the end-provider, or by any other system that may interfere with the present invention. For each action, the provider can also attach an interaction form that is filled in by the entity that has performed the interactions to provide feedback for the provider.

A provider can create a profile of possible end-providers. This profile can be used to assign incoming requests to an appropriate end-provider. The provider can then manage its end-providers by adding their information to the system, organizing them into groups, and defining their privileges to perform actions.

During the subscription process, the provider may also identify partners that the provider would like to route requests to, in the event that the provider declines to handle a request. A provider may also attach a policy script for each business event that may occur. Each script might be executed immediately after the corresponding event occurs. A perfect practice is to attach a policy to each form designed by the provider. For instance, the provider may define an “Arrival of Request” policy, which will be executed the moment a new request form is fed into the system. The provider may use the “Arrival of Request” policy as an opportunity to define a routing policy for new requests. Using the information filled in by the requester, the routing policy governs the routing of a request to an end-provider.

As an example, it may be desirable to offer policies for the following events: “End-provider sends a message to the requester”; “End-provider sends a service or product quote to the requester”; “The end-provider provides the requested information”; “The requester accepts the quote”; or “The requester declines the quote.” One skilled in the art would appreciate that the above list is not intended to be exhaustive. A policy may be attached to any event. The provider may also define an event to attach a policy to, based on another policy, and not based upon a user action. A policy can be based on a list of “if-then” rules. Each rule has a condition, and a list of actions to be performed when said condition is satisfied.

A condition is built from Boolean literals that are combined using Boolean operators like AND, OR, or NOT. Generally each Boolean literal contains a reference to one of the request's fields (for instance, the requester's annual income), a reference to the operator, and the compared value (that can manually be filled in or be a reference to another field). The operators include arithmetic operators (i.e., =, <,>) and string operators (i.e., “contains,” “starts with”). Other complicated rules might include reference to a collection of fields, or to other data from the system, such as data related to former events (when did they occur, etc.). Actions can be of any type that is performed on a request to change its status or its data. This would include assigning the request to an “end-provider”, or a group of “end-providers,” sending a notification, routing the request to a partner, the transferring of a request between different end-providers, rejecting the request, locking the request, etc. Actions can also be related to other entities located within the system or beyond (i.e., communicating data to external systems, etc.).

The routing policy may define the following:

Under what conditions the request should be handled by the provider itself, and to what end-provider(s) or computer(s) the request will be routed. In the case of routing to a computer, the response to the requester can be automatic.

Under what conditions the request will be routed to one or more of the providers (who have already been identified by the provider).

Under what conditions the provider agrees to route the request to other subscribed providers, which are unknown in advance, and are not competitors, but are willing to handle the request.

The provider may also define whom it considers a competitor.

Upon occurrence of an event, the system should be fed with a record containing the event type, the data required for executing the policy attached to this event type, and the execution time of the policy (which can be an ASAP execution, or a specific date and time). The above record is stored in a queue that is sorted according to the execution time. The system will poll one record at a time (the queue can only poll records whose execution time has come) and invokes the policy script, thereby deciding what actions should be performed by the system. The data attached to a record is stored in the system's database for future use. The system could be fed records from various sources. For example, the system could be fed by an ERP or Workflow system, or by the system itself (when one policy invokes another policy).

Upon the arrival of a request, which may come directly from the requester, or be routed to the provider, by the lead system, the request data and a reference to the corresponding event type (“Arrival of Request”) is stored in the queue. When the time has come for the system to process the request, it will, according to the provider “Arrival of Request” policy script, determine what actions should be performed on the request. For instance, the system may use the “Arrival of Request” policy to decide which end-provider should be assigned to handle the request.

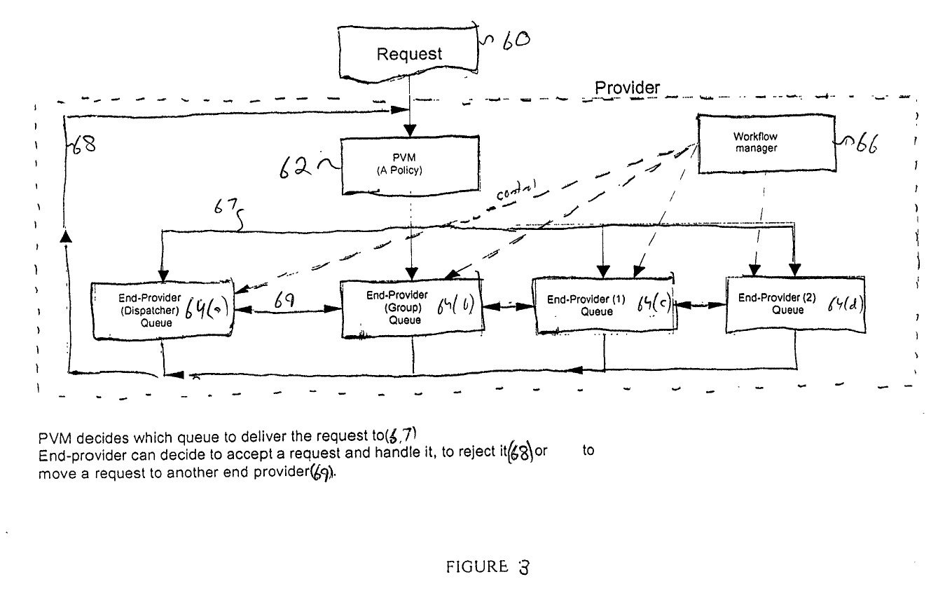

If according to the provider policy the request can be handled “in-house,” then the request is routed internally (either automatically or manually) to a suitable end-provider or end-provider group. The request will then be appended to one of the pending lists of the chosen end-provider, either in a queue, or a buffer. An authorized end-provider may connect to the lead system, and view the provider's pending lists according to his/her privileges. The end-provider can scan the list, and either decide to handle the request, or decide the request should be assigned to a different pending list of the provider, or decide whether the request should be routed externally to the provider or provider group, such as to a partner of the provider. “In-House routing” refers to inner routing, indoor routing, or to the routing of a request within a company. FIG. 3 illustrates an example of in-house routing. A request (step 60) is received by the PVM of the provider (step 62). Based upon the PVM (step 62), the request (step 60) is routed (step 67) to a queue of an end-provider that is a sub group of the provider (steps 64(a)-(d)). The end-provider can decide to handle a request, reject it (step 68), or move the request to another end-provider (step 69). Alternatively, the request (step 60) can be originally routed to the end-providers (steps 64(a)-(d)) by the workflow manager (step 66).

If the end-provider decides to handle the request, the request will be moved to the endprovider's personal pending list. From this personal list, the end-provider may interact with the requester according to interaction forms that have been defined by the provider (e.g., messaging, provide the service, provide the requested information, write service or product quote). This process proceeds until the request is declared as “handled,” or until the end-provider decides to deliver the request to another pending lists for further handling. The type of actions an end-provider can perform is defined according to that end-provider's system privileges.

It should be noted that the provider can decide, as part of its policy, that in order to interact with an end-provider(s), other than the provider, the requester will be required to log in through the provider's original entry point into the system (e.g., web site).

Using the System from a Requester's Point of View

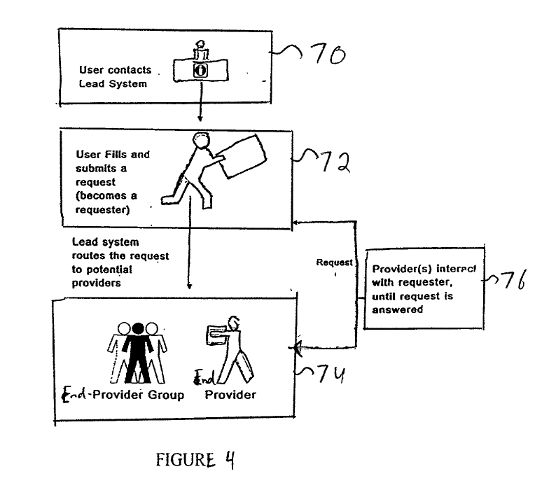

FIG. 4 illustrates one embodiment of the present invention. A user contacts a lead system (step 70). In one example this could be via a home or mobile computer device. The user submits a request containing request information to the lead system (step 72). This could be via a World Wide Web page, or other electronic interface. The lead system routes the request to an appropriate end-provider(s) the mechanics of which are disclosed below (step 74). Finally, the end-provider(s) interact with the user until the request has been satisfactorily answered (step 76).

The method begins when a requester connects to a provider server, and describes its request by filling in a request form that is provided by the provider. A provider server may, for example, be a web site on the World Wide Web, but need not be.

The typical embodiment of the method might be described from the user or requester's point of view as follows:

A requester enters a networked section of the system, for example an Internet site of the provider, where he/she can provide data about a request he/she has (e.g., a request form). After the request is submitted to the lead system, the requester might be notified by the system by means of a network (e.g., e-mail, WAP, or web dynamic pages) when a provider has responded to the request, or when several providers have responded. If no provider has responded within a period defined by the requester, and/or by the subscribed company, the lead system can optionally notify the requester that the company cannot handle the request. To accomplish the above delayed notification, the provider should use a policy that is initialized by the policy attached to the “Arrival of Request” event.

The requester may then add information to his request or interact with the provider(s) using the various interaction forms defined by the provider, receive information, such as a quote for the service or product, and trade with the provider(s) within the system. This process of interaction might be lengthy, or short, on-line, or with breaks.

In the case where a requester has logged out, or disconnected from the system, the system will request identification data the next time the requester logs in/connects to the system, and then refer the requester to his/her current unanswered requests.

After a provider has supplied a sufficient answer to the requester's needs, the requester can acknowledge that he/she has been satisfied by the response, and the request can then be marked as “complete.”

Using the System from the Provider's Policy Manager's Point of View

The process may be described from the provider's policy manager's point of view as follows: One, or more policy managers may log into the lead service to perform maintenance tasks, such as the change of request data forms or any other forms, changing event policies, or to view and manage request data, such as processing reports, or the handling of exceptions. The policy managers have interfaces enabling them to change and verify policies, enforce rules, such as regarding provider's and partner's privileges.

The Routing of Requests

A requester, through a computerized request generating mechanism, initiates a request. The request is submitted after the requested data is filled in by the requester. The request may be submitted via a submitting mechanism to a lead system. A submitting mechanism, however, does not have to be a part of the lead system. The lead system, however, generally operates according to the policies defined in the requests.

The lead system has a routing mechanism. The routing mechanism of the lead system receives the request and marks the source of the request on the request. The request data structure is of a type that can be manipulated dynamically, and additional data may be added to it by processing mechanisms, such as the routing mechanism, at any time. Marking the request is essentially adding data to the request, such as by adding a cookie. The routing mechanism routes the request according to the rules defined in the source company's policy.

Assigning a request to an end-provider or to a group of end-providers can be implemented by three different methods:

1. Explicit Assignment: An explicit assignment is the assignment of the request to a specific end-provider, or to a specific group of end-providers. For instance, if the requestor lives in NY, and his income is greater than $100,000, then assign the request to Roger Ross, and if the requester's income is less than $100,000, or the requester does not live in New York, then assign the request to the Non-VIP group.

2. Inexplicit Assignment: The assignment of the request to end-providers that fulfill specific conditions: For instance, assign the request to all end-providers that work in NY, and are categorized as senior advisors.

3. Automatic Assignment: The assignment of the request by classifying the request to the appropriate end-provider. To achieve this goal, one can use a classification algorithm, taking into consideration that the request may be assigned to more than one end-provider, and that the classification algorithm should be able to handle different types of information items (for instance, number, category values and free-text). A relevant embodiment will be using the Support Vector methodology as described in Vapnik V. (1998). Statistical Learning Theory. Chichester, UK: Wiley, the contents of which are incorporated herein by reference.

The routing mechanism routes the request to a provider, to a business partner, or to another subscriber provider on the World Wide Web, as follows:

Inner routing: To a provider or provider group within the company.

BP Routing: To a business partner or business partners of the company.

WWW Routing: To the “World Wide Web” Service within the lead system, meaning the lead system can reroute the request to any subscribed company it finds suitable (non-competitive with the source company).

The lead system provides a further routing mechanism that routes the request within the provider to an end-provider. That occurs according to end-provider specific policies.

The lead system may also supervise the handling of the request. Such supervision may be accomplished by marking any request for further tracking and inspection and define time and event driven actions, such as tracking the processing of a request routed to the “support” queue inside the company, and if not answered within three days, reroute it to another provider, such as a management group.

In-house Routing

In-house routing is routing within the company. This routing is a process where a request is sent to a provider that is comprised of a group of end-providers. It is understood that “provider” means one or more end-providers within the provider.

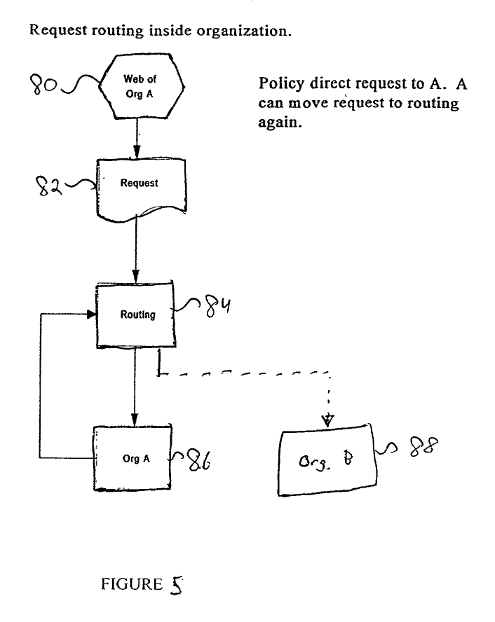

FIG. 5 illustrates the routing of a request within a provider. At steps 80 and 82, Organization (hereinafter, “Provider”) A receives on its network the user request. At steps 84 and 86, Provider A routes the request to an appropriate end-provider in provider A or to a group of end-providers (not shown) in provider A according to policy. However, should the end-provider within Provider A be unwilling or unable to handle the request, the request reroutes to another provider, Provider B, at step 88.

The policies specific to the provider govern how the request is further routed to a queue in a computer of an end-provider. According to his/her privileges, the provider(s) can then:

“Take” the request, meaning to lock it so as to prevent other providers/end-providers from handling it.

“Block” the request, meaning to mark it so that the request cannot be routed to that provider again. Thus, the provider will not be fulfilling the request.

Reject the request, meaning, returning it to the routing mechanism for rerouting, marking it not to return to the queue it came from.

Forward to another provider, in-house or externally (take the action of the type the routing mechanism does), moving it to that provider's queue and removing it from the current provider's queue.

Routing to a Partner

When a company's policy defines that a request is to be routed to, and handled by a business partner, or when a system user (i e., provider or manager) defines that a request should be routed to a provider outside of the company, the lead system will move or reroute the request to the other company's entrance point, which means that it will reroute the request using the second provider/company's policy. This procedure is identical to the situation where the request is initially sent to the second company's routing mechanism, only that the source of request data will not be run-over, or marked, with the first company's source information. Rather, the original source, or marking of the request, will be preserved. From here on, the routing is operated by the lead system in a manner similar to the routing described.

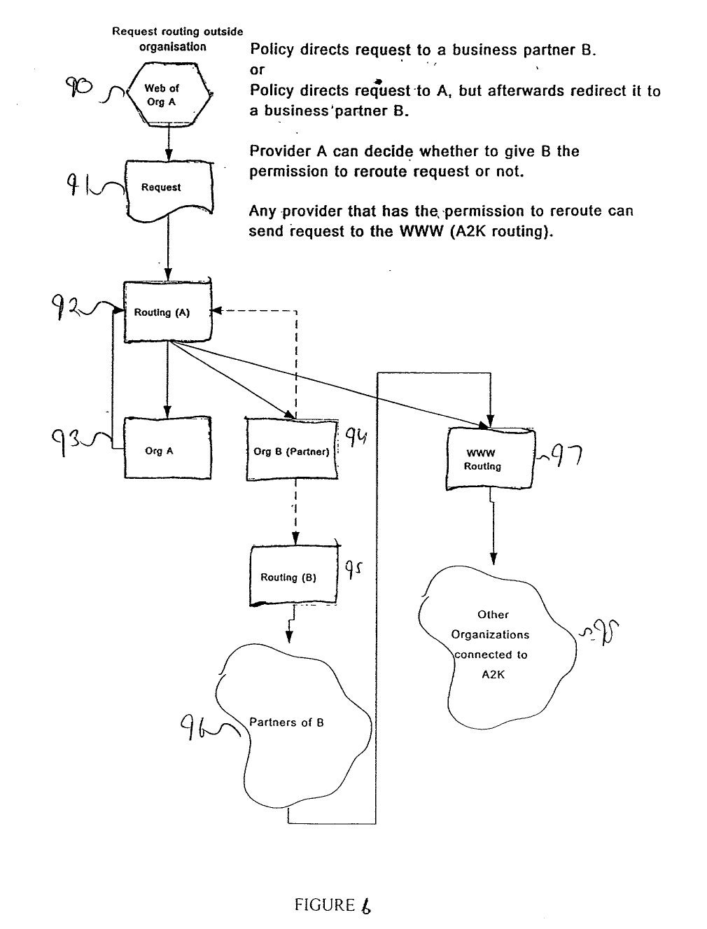

FIG. 6 illustrates an example of routing outside of a provider. At steps 90 and 91, Organization (hereinafter, “Provider”) A receives on its network the user's request. At step 92, the system decides, according to Provider A's policy, whether to route it internally (Step 93), to a partner (Step 94), or to WWW routing (Step 97). In step 95, the request can then be routed to the most appropriate end-provider in Provider B or the most appropriate end-provider's group. The system avoids routing the request to competitors of the original provider.

WWW Routing

When a company's policy defines that the company's providers would not handle a request, and nor will the company's business partners, the lead system may, according to the policy defined by the source company, reroute the request to a center lead system, that might identify a subscribed company(s) willing and fitting to provide for the request, I. If so, the subscribed company's routing mechanism(s) will process the request and respond according to policies. The identification of a subscriber company in the center lead system is on the World Wide Web, 97. The request service can assure that the non-affiliated provider, 98, is not a competitor of the original provider, if the original provider so desires.

The method is illustrated by the following examples:

### EXAMPLE 1

A software company, A, develops different software products. A does not sell such products to small companies, but uses subcontractors/resellers in different geographic areas for selling the products to small organizations. Furthermore, A does not supply any application consulting services for its products. However, A does supply general and marketing information and provides customer support for several of its products.

A customer (i.e., requester) who is interested in buying one of A's products, or in retaining the services of a consultant who may consult concerning such products, may have the wrong impression that A handles all kinds of requests. For that reason, he will probably fill in a request form in A's web site for any services or products that pertain to A's products.

To handle the requests, the company may design a request information form that will include the following fields:

The contact information of the requester, including physical address, and e-mail address.

Information about the requester organization, if any, for example: yearly revenue, and/or the number of employees.

The name of the product that the requester is interested in.

The type of request: i.e., general information inquiry, consulting, purchases, support, etc.

The description of the request in free text.

The policy of A or its “provider policy script” may be composed of rules, an example of which follows:

If the requester wants to get general information about one of the products, the request will be routed to the suitable group in the marketing department that handles this product.

If the requester wants to buy one of the products, and his organization is bigger than 500 employees, then the request will be routed to the suitable group in sales department that handles this product.

If the requester wants to buy one of the products, and his organization is smaller than 500 employees, then the request will be routed to the suitable reseller (partner) according to the requester's location (the requester address).

If the requester wants support on a product that is supported by A, then the request will be routed to the suitable group in the support department that handles this product.

If the requester wants support on a product that is not supported by A, then the request will be routed automatically by the service to other companies subscribed to the service that may be able to provide the requested support.

If the requester wants consulting on one of A's products, then the request will be routed to A's business partners according to either the product, the requester organization, or the requestor's location.

### EXAMPLE 2

A Human Resource department may use the present invention to support the smart matching and routing of resumes, personnel, open positions, and the hiring processes, based on sophisticated policies. On the receipt of a new resume, a corresponding policy will be invoked. A typical policy in this case might contain the following rule: “If there is a vacant position with the same skill set as an incoming resume, this resume is assigned to the appropriate manager, and issue an e-mail to the candidate saying that the resume is under review; but if there is no vacancy, then an e-mail is sent to the candidate, thanking him/her for his/her interest in the company.”

Whenever the appropriate manager reviews the resume, the manager might decide to schedule a meeting. In that case, the corresponding policy may schedule a meeting, and send an e-mail notification to the candidate. Alternatively, the manager may turn down the candidate, and, in that case, an e-mail thanking the candidate could be issued automatically.

Specific embodiments of the invention have been described herein for purposes of illustration only. One skilled in the art would appreciate that various modifications may be made to the embodiments described herein without departing from the spirit and scope of the invention. The spirit and scope of the invention may be defined by reference to the following claims, along with the full scope of their equivalents:

What is claimed is:

1. A method of processing a user request from a user, said method comprising the steps of:
(a) receiving a user request wherein said user request includes request data; and
(b) routing said user request, based on at least one of said request data and a user profile, to an end-provider, according to a routing policy of a provider, wherein said routing policy includes a plurality of rules being at least one of interpretable and executable by a computer.

2. The method of claim 1, wherein said request data is formatted into a data structure.

3. The method of claim 2, wherein said computer processes said routing policy using said data structure.

4. The method of claim 1, wherein the step of routing is further based on a end-provider profile, wherein said end-provider profile defines at least attributes of said end-provider.

5. The method of claim 1, further comprising the step of:
(c) dynamically generating a request form based upon a request form definition provided by a provider, wherein said request form definition defines request data fields, such that said request data fields correspond to said request data.

6. The method of claim 1, further comprising the step of:
(a1) displaying said request form to said user for the input of said request data.

7. The method of claim 1, wherein said routing policy includes an instruction not to route said user request to a predetermined competitor of said provider.

8. The method of claim 1, wherein said routing policy includes an instruction to forward a notification to said user if said at least one end-provider has not accepted said user request within a predetermined period of time.

9. The method of claim 1, wherein said routing policy includes an instruction to forward said user request to a non-partner provider if said at least one end-provider has not accepted said user request.

10. The method of claim 1, wherein said routing policy requires a processing of said user request within a predetermined period of time.

11. The method of claim 1, wherein said routing policy determines the order in which said user request is processed in relation to a plurality of other requests.

12. The method of claim 1, wherein said request data includes system required data.

13. The method of claim 1, wherein said request data includes application required data, wherein said application required data is data agreed to by a plurality of providers that share a common request system.

14. The method of claim 1, wherein said request data includes proprietary routing data, wherein said proprietary routing data is data used to perform inner policy decisions.

15. The method of claim 1, wherein said request data includes variant routing data, wherein said variant routing data is data used to satisfy a specific non-routing application.

16. The method of claim 1, wherein said at least one end-provider is said provider.

17. The method of claim 16, wherein said user request is re-routed to at least one partner provider after a rejection by said provider.

18. The method of claim 1, wherein said at least one end-provider is at least one partner provider of said provider.

19. The method of claim 18, wherein said at least one partner provider is selected from a plurality of partner providers based on an end-provider profile.

20. The method of claim 1, further comprising the step of:
(c) said at least one end-provider providing a quote to said user based upon said user request.

21. The method of claim 20, further comprising the step of:
(d) receiving a response to said quote from said user.

22. The method of claim 1, further comprising the step of:
(c) receiving an event policy to control the processing of an event from said provider.

23. The method of claim 22, wherein said event is said at least one end-provider forwarding a message to said user.

24. The method of claim 22, wherein said event is said at least one end-provider forwarding a quote to said user, wherein said quote further comprises monetary cost.

25. The method of claim 22, wherein said event is said at least one end-provider providing requested information to said user.

26. The method of claim 22, wherein said event is said user accepting a quote.

27. The method of claim 22, wherein said event is said user declining a quote.

28. The method of claim 22, wherein said event policy requires a processing of said event within a predetermined period of time.

29. The method of claim 22, wherein said event policy determines the order in which said event is processed in relation to a plurality of other events.

30. The method of claim 1, further comprising the step of:
(c) said at least one end-provider providing a response to said user request to said user.

31. The method of claim 1, wherein said at least one end-provider is a partner provider of said provider.

32. The method of claim 1, wherein said at least one end-provider is a sub group of said provider.

33. The method of claim 32, wherein said user request is re-routed from said sub group of said provider to a second subgroup of said provider.

34. The method of claim 1, wherein said user request is queued along with a plurality of other user requests.

35. The method of claim 1, further comprising the step of:
(c) said at least one end-provider interacting with said user to request additional request data.

36. A method for a provider to configure and manage a request service, wherein said request service processes user requests for a service, from one or more users, said method comprising the steps of:
(a) subscribing to said request service;
(b) providing a request form definition to said request service, wherein said request form definition defines request data fields, such that a subsequent user request for a service includes request data corresponding to the request data fields; and
(c) providing a routing policy to said request service to determine the protocol for routing said request to at least one end-provider, such that said request is routed based on said request data to at least one end-provider based on said routing policy of said provider.

37. The method of claim 36, further comprising the step of:
(d) designating at least one partner provider of said provider.

38. The method of claim 37, further comprising the step of:
(e) providing an end user profile of said at least one partner provider of said provider.

39. The method of claim 36, wherein said request data includes system required data.

40. The method of claim 36, wherein said request data includes application required data wherein said application required data is data agreed to by a plurality of providers that share a common request system.

41. The method of claim 36, wherein said request data includes proprietary routing data wherein said proprietary routing data is data used to perform inner policy decisions.

42. The method of claim 36, wherein said request data includes variant routing data wherein said variant routing data is data used to satisfy a specific non-routing application.

43. The method of claim 36, wherein said at least one end-provider is said provider.

44. The method of claim 36, wherein said at least one end-provider is a sub group of said provider.

45. The method of claim 36, wherein a user request is re-routed to at least one partner provider after a rejection by said provider.

46. The method of claim 36, wherein said at least one end-provider is at least one partner provider of said provider.

47. The method of claim 46, wherein said at least one partner provider is selected from a plurality of partners based upon an end-provider profile.

48. The method of claim 36, wherein said routing policy includes an instruction not to route a user request to a competitor of said provider.

49. The method of claim 36, wherein said routing policy includes an instruction to forward a notification to a user if at least one end-provider has not accepted a user request within a predetermined period of time.

50. The method of claim 36, wherein said routing policy includes a directive to forward a user request to a suitable non-partner provider if at least one end-provider has not accepted said user request.

51. The method of claim 36, wherein said routing policy requires a processing of user request within a predetermined period of time.

52. The method of claim 36, wherein said routing policy determines the order in which a user request is processed in relation to a plurality of other requests.

53. The method of claim 36, further comprising the step of:
(d) providing a quote to a user based upon a user request, wherein said quote comprises a monetary cost.

54. The method of claim 36, further comprising the step of:
(d) providing an “event policy” to control the processing of an event from said provider.

55. The method of claim 54, wherein said event is at least one end-provider forwarding a message to a user.

56. The method of claim 54, wherein said event is at least one end-provider forwarding a quote to a user.

57. The method of claim 54, wherein said event is at least one end-provider providing requested information to a user.

58. The method of claim 54, wherein said event is a user accepting a quote.

59. The method of claim 54, wherein said event is a user declining a quote.

60. The method of claim 54, wherein said event policy requires a processing of said event within a predetermined period of time.

61. The method of claim 54, wherein said event policy determines the order in which said event is processed in relation to a plurality of other events.

62. The method of claim 36, further comprising the step of:
(d) providing a response to said a user's request.

63. The method of claim 36, further comprising the step of:
(d) interacting with a user to request additional request data.

64. A system for processing a user request from a user, comprising:
a first input configured to receive request data from a user;
a second input configured to receive a routing policy from a provider, wherein said routing policy includes a plurality of rules being at least one of interpretable and executable by a computer;
a first processor configured to receive said request data from said first input and said routing policy from said second input, and to make a routing decision based on at least one of said request data and a user profile, to an end-provider, according to said routing policy; and
a first output configured to receive said routing decision from said processor and route said request data to at least one end-provider according to said routing decision.

65. The system of claim 64, wherein said request data is formatted into a data structure.

66. The system of claim 64, wherein said first processor makes said routing decision by processing said routing policy using said data structure.

67. The system of claim 64, wherein said first processor processes an end-provider profile to make said routing decision, wherein said end-provider profile defines at least attributes of said end-provider.

68. The system of claim 64, further comprising:
a second processor configured to dynamically generate a request form based upon a request form definition provided by a provider, wherein said request form definition defines request data fields, wherein said request data fields correspond to said request data.

69. The system of claim 64, wherein said request data includes system required data.

70. The system of claim 64, wherein said request data includes application required data, wherein said application required data is data agreed to by a plurality of providers that share a common request system.

71. The system of claim 64, wherein said request data includes proprietary routing data, wherein said proprietary routing data is data used to perform inner policy decisions.

72. The system of claim 64, wherein said request data includes variant routing data, wherein said variant routing data is data that can be used to satisfy a specific non-routing application.

73. The system of claim 64, wherein said at least one end-provider is a provider.

74. The system of claim 73, further comprising:
a second output configured to re-route said user request to at least one partner provider after a rejection by said provider.

75. The system of claim 64, wherein said at least one end-provider is at least one partner provider of a provider.

76. The system of claim 75, wherein said at least one partner is selected from a plurality of partner providers based upon an end-provider profile.

77. The system of claim 64, wherein said routing policy includes an instruction not to route said user request to a competitor of said provider.

78. The system of claim 64, wherein said routing policy is further comprising an instruction to forward a notification to said user if said at least one end-provider has not accepted said user request within a predetermined period of time.

79. The system of claim 64, wherein said routing policy includes an instruction to forward said user request to a suitable non-partner provider if said at least one end-provider has not accepted said user request.

80. The system of claim 64, wherein said routing policy requires a processing of said user request within a predetermined period of time.

81. The system of claim 64, wherein said routing policy determines the order in which said user request is handled in relation to a plurality of other requests.

82. The system of claim 64, further comprising:
a third output configured to output a quote to said user based upon said user request, wherein said quote may be further comprised of a monetary cost.

83. The system of claim 82, further comprising:
a third input configured to receive a response to said quote from said user.

84. The system of claim 64, further comprising:
a fourth input configured to receive an event policy to control the processing of an event from said provider.

85. The system of claim 84, wherein said event is said at least one end-provider forwarding a message to said user.

86. The system of claim 84, wherein said event is said at least one end-provider forwarding a quote to said user.

87. The system of claim 84, wherein said event is said at least one end-provider providing requested information to said user.

88. The system of claim 84, wherein said event is said user accepting a quote.

89. The system of claim 84, wherein said event is said user declining a quote.

90. The system of claim 84, wherein said event policy requires a processing of said event within a predetermined period of time.

91. The system of claim 84, wherein said event policy determines the order in which said event is processed in relation to a plurality of other requests.

92. The system of claim 64, further comprising:
a fourth output configured to output a response to said information request, to said user.

93. The system of claim 64, wherein said at least one end-provider is a sub group of a provider.

94. The system of claim 93, further comprising:
a fifth output configured to output said user request to a second subgroup of said provider upon the non-acceptance of said subgroup of said provider.

95. The system of claim 64, further comprising:
a queue configured to queue said user request along with a plurality of other requests.

96. The system of claim 64, wherein said at least one end-provider can only act within the bounds of a privilege status of said at least one end-provider.

97. The system of claim 64, further comprising:
a sixth output configured to output at least one follow up question to said user; and
a fifth input configured to receive at least one answer from said user to said at least one follow up question.

98. A system for interfacing with a request system comprising:
a first input configured to receive a request form from said request system wherein said request system provides said request form based upon a request form definition provided by a provider, wherein said request form defines request data fields, such that a subsequent user request for a service includes request data corresponding to the request data fields;
a first output configured to display said request form to a user;
a second input configured to receive said request data from said user; and
a second output configured to receive said request data, and output said request data to said request system, wherein said request system forwards said request to at least one end-provider according to a routing policy, wherein said routing policy includes a plurality of rules being at least one of interpretable and executable by a computer.

99. The system of claim 98, wherein said request data is formatted into a data structure.

100. The system of claim 98, said system further comprising:
a third input configured to receive a quote from said request system, wherein said quote may be further comprised of a monetary cost;
a fourth input configured to receive a quote response from said user; and
a third output configured to output said quote response to said request system.

101. The system of claim 98, said system further comprising:
a fifth input to receive a quote answer from said request system; and
a fourth output configured to display said quote answer to said user.
